(19) United States
(12) Patent Application Publication
(10) Pub. No.: US 2008/0157516 A1
(43) Pub. Date: Jul. 3, 2008

(54) Binding System, Sheet For Appliance In a Binding System and Use of a Binding System

(76) Inventor: Paul Gokkel, Bloemendaal (NL)

Correspondence Address: BROOKS KUSHMAN P.C., 1000 TOWN CENTER, TWENTY-SECOND FLOOR, SOUTHFIELD, MI, 48075, US

(21) Appl. No.: 11/816,645

(22) PCT Filed: Feb. 21, 2006
(86) PCT No.: PCT/NL2006/000088

§ 371 Date: Aug. 20, 2007

(30) Foreign Application Priority Data
Feb. 22, 2005 (NL) 1028365
Dec. 23, 2005 (NL) 1030759

(51) Int. Cl. B42D 5/00; B42D 13/00; B42F 3/00

(52) U.S. Cl. 281/38

(57) ABSTRACT

A binding system (1) comprising a stack of sheet (2), each with a binding side (3) with attachment means for the connection of the sheets. The binding side of a sheet possesses an alternating sequence of tabs and notches. One sheet can be attached to an adjacent sheet by interlocking its tab (4) into the notches between the corresponding tabs of the adjacent sheet. The tabs fit exactly into these notches to provide a seamless connection between these sheets. Thus this binding system provides for a quick, user-friendly binding system without requiring separate and cumbersome attachment means.

The present invention relates to a binding system, comprising a stacking of sheets that are mutually connected at a common binding edge using attachment means. Said sheets are provided with tabs and notches at their binding edge.

Binding systems using sheets with tabs and notches are well known in the patent literature. GB190924983 describes sheets provided with tabs and notches that can be attached to a cover. GB257322 describes tabbed sheets with notches, through which anchoring bars can be clung. JP52020127 and WO0178995 use sheets with notches and tabs that can be glued together. The glue penetrates the notches to obtain a stronger adhesion in these cases. A disadvantage of such a binding system is the drying time that is needed for this glue, the lack of durability and the special means needed to implement the adhesive. Also said attachment means need to be purchased separately increasing therefore the cost price and requiring a certain stock. Many alternative existing binding systems use binding combs or binding covers to bind loose leafs. To handle booklets of varying thickness several sizes of such combs or covers are required. The present invention has the purpose to provide for a binding system that alleviates the above problems and disadvantages as mentioned. To achieve the intended purpose the binding system as mentioned according to the invention is characterised by attachment means comprising tabs, regularly positioned on the binding edge of each sheet. Between two neighbouring tabs there is situated a notch. During the binding process according to the present invention the tabs of one sheet are inserted into the notches of an adjacent sheet to attach these sheets. In this way a reliable attachment is attained, with tabs of successive sheets co-operating to implement a mutual connection, in which further connection means like glue, binding combs or covers are redundant. If required, loose sheets can be added to the bound sheets or sheets can be removed from these bound sheets.

This yields both economic as well as practical advantages, through which the home use of such a binding system is stimulated.

A preferred embodiment of the binding system according to the invention is characterised by tabs, comprising a main section projecting from one edge of the sheet. Each main section has a proximal part and a distal part. The distal part of said main section possesses protrusions that leave open recesses. These recesses extend, along the edge of the sheet from which the tab projects, from the base of the main section to the notches between the tabs. The binding is implemented by clenching the main section of the tabs of one sheet into the recesses of an adjacent sheet. Hereby a part of the base of the main section fits exactly or with a minor tolerance into a recess of the tab of an adjacent sheet. These tabs assure a reliable seamless attachment of two successive sheets to a particularly coherent and firm unity, in which the above protrusions act as a catching means.

A preferred embodiment of a binding system according to the invention is characterised by tabs, whose main section has a width tuned to the distance between the main sections of two neighbouring tabs on a consecutive sheet. In particular the width of each main section, at its base, is equal or slightly less than the distance between two adjacent main sections. This is preferable for obtaining a good alignment of successive sheets along the direction of the binding edge.

Another embodiment of the binding system is characterised by tabs, in which between the main section and the protrusions a weakening in the form of a folding line or crease is situated. This facilitates the bending of the protrusions during the insertion of the tabs into corresponding notches of an adjacent sheet. During the binding process, if a tab is inserted into a notch between two corresponding tabs on the other sheet, the protrusions of these tabs are bent so that said first tab can pass through the notch between said corresponding tabs.

A preferred embodiment of the binding system according to the invention is characterised by tabs whose main section comprises, along its base where the tab projects from the rest of the sheet, a weakening in the form of a folding line, perforated line or crease. During the binding process the entire tab can be folded along this folding line to facilitate the above mentioned procedure for the manufacture of books with multiple pages. Also the tabs can be folded exactly along these folding lines to yield a binding side with uniform and beautiful appearance.

Another preferred embodiment of the binding system according to the present invention is characterised by sheets, that comprise the same pattern of tabs, regularly positioned on the binding edge of each sheet. In this case adjacent sheets are turned upside down, so that the tabs of a arbitrary sheet lie directly above the notches of a neighbouring sheet. In this embodiment the binding edge starts with a tab and ends with a notch or the reverse. It offers both an economic and practical advantage as only one type of sheets needs to be used. Without this configuration one needs to use two different types of sheets.

Another embodiment of the binding system according to the invention comprises a first type of sheet, that starts and ends with a tab, and a second type of sheet, that starts and ends with a notch.

A preferred embodiment of a binding system according to the invention is characterised by sheets that comprise a printable material like paper, cardboard or plastic foil. Such materials can be printed easily with various printing techniques. This way sheets can be easily provided with prints if desired.

Another embodiment of the binding system according to the present invention uses tabs that comprise an additional adhesive, in particular a glue layer, hot melt glue layer or self-adhesive layer. This yields a permanent and more powerful attachment of the sheets.

A preferred embodiment of the binding system according to the present invention uses only two sheets to be connected to manufacture a poster. With an ordinary printer the size of the paper is generally limited. Using the present invention one can double the paper size.

The present invention also relates to a sheet for use in a binding system, according to the invention, and the use of the binding system, according to the invention, for the manufacture of books, brochures, magazines, photo albums, posters or other bound matter. To manufacture above bound matters with more than two pages, one first connects two sheets, according to the above described prescription. Then the tabs of the lower sheet are folded back onto the upper sheet. Only the tabs of the upper sheet are left unfolded. A new sheet is placed upon said pair connected sheets, with its tabs positioned directly above the resulting notches of the connected pair. After this the tabs of the new sheet are pushed into these notches. Now the tabs of the middle sheet of the triple are folded back onto the upper sheet of the triple. For more pages one can repeat this procedure.

The present invention will be further elucidated here below with reference to the annexed figures of several examples of embodiments.

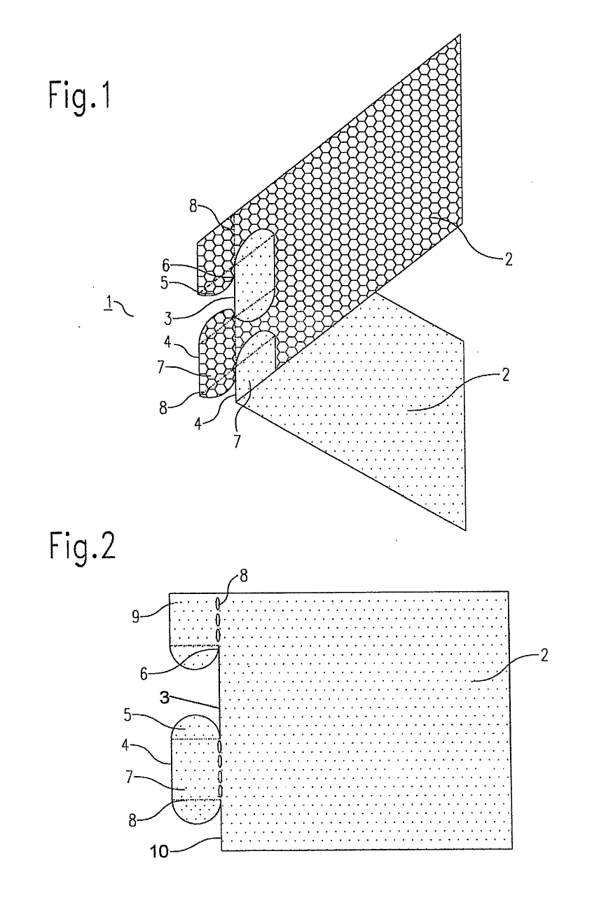

FIG. 1 a perspective view of an example of an embodiment of the binding system according to the invention comprising two sheets bound together.

FIG. 2 a top view of an example of an embodiment of a sheet used in the binding system according to the invention.

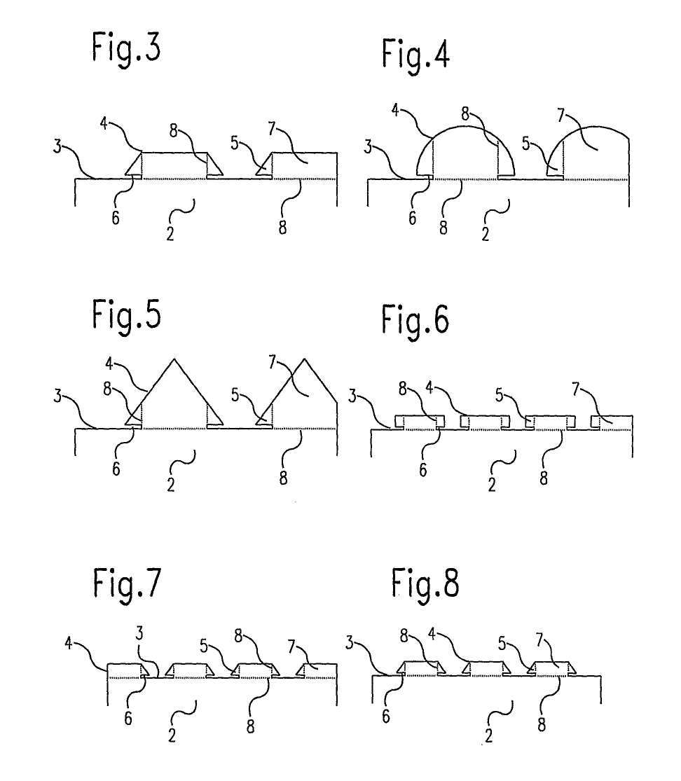

FIG. 3-8 a top view of the binding edge of six further examples of embodiments of sheets used in the binding system according to the invention.

FIG. 9 a perspective view of the consecutive stages of the binding process of the binding system according to the invention.

The figures are otherwise schematic and not drawn to scale. For the sake of clarity some dimensions, in particular, may be exaggerated to a greater or lesser extent. Corresponding parts are designated, as far as possible, in the figures with the same reference numerals.

An example of an embodiment of a binding system according to the invention is depicted in FIG. 1 in perspective view. The binding system 1 comprises two sheets 2 that at their binding edge 3 are provided with attachment means in the form of approximately oval shaped tabs 4. Another suitable shape of the tabs 4 is for instance triangular, square, polygonal, trapezoid or circular. The tabs 4 comprise a main section 7 that on both sides possesses protrusions 5 that leave open recesses 6 adjacent to the binding edge 3 of a sheet 2. During the binding process a main section 7 of a tab 4 belonging to a first sheet 2 is inserted into the recesses 6 of neighbouring tabs 4 of second sheet 2. So a durable mutual attachment is attained. The protrusions 5 form the attachment means hereby.

The main section 7 of a tab 4 has a width tuned to the distance between the main sections 7 of two neighbouring tabs 4 on a consecutive sheet 2. In particular the width of each main section 7, at its base, is equal or slightly less than the distance between two adjacent main sections 7. Hereby a part of the base of the main section 7 fits exactly or with a minor tolerance into a recess 6 of the tab 4 of an adjacent sheet 2. During the binding process, if a tab 4 is inserted into the notch between two corresponding tabs 4 on the other sheet 2, the protrusions 5 of these tabs 4 are bent along the folding lines 8. The folding of the protrusions 5 narrows the width of the tabs 4 to the width of their main sections 7 so that said first tab 4 can easily pass through the notch between said corresponding tabs 4. This folding line 8 can be implemented as a weakening in the form of a crease or line of perforations and facilitates the insertion of the tabs 4 into the notches. For thin and flexible sheet material like for instance paper or thin plastic foil the folding of the protrusions 5 happens of itself during the insertion of the tabs 4 and this crease or line of perforations 8 can be omitted.

In FIG. 1 the two sheets 2 can also be connected to manufacture a poster. Thus the above mentioned example of an embodiment provides for a quick, user-friendly binding system without requiring separate and cumbersome attachment means.

FIG. 2 depicts a top view of an example of an embodiment of a sheet 2 used in the binding system according to the invention. The sheet 2 comprises at its binding edge 3 attachment means in the form of approximately oval shaped tabs 4. The tabs 4 comprise a main section 7 that on both sides possesses protrusions 5 that leave open a recess 6 adjacent to the binding edge 3 of the sheet 2. During the binding process a main section 7 of a tab 4 belonging to first sheet 2 is inserted into the recess 6 of the tabs 4 of second sheet 2. So a durable mutual attachment is attained. The protrusions 5 form the attachment means hereby. The tabs 4 are also provided with a folding line in the form of a crease or perforated line 8 along the base of the main section 7, where the tabs 4 project from the binding edge 3 of the sheet 2 . This also facilitates the insertion of tabs 4 of a sheet 2 into the notches between the tabs 4 of an adjacent sheet 2 and the successive folding of the tabs 4 flat onto that adjacent sheet 2. In this figure the binding edge starts with a begin-tab 9 and ends with a end-notch 10. To assure a proper alignment of successive sheets 2 along both edges orthogonal to that binding edge 3, the width of the main section 7 of the begin-tab 9 must be equal or slightly less than the width of the end-notch 10. Also the begin-tab 9 comprises only one protrusion.

The FIGS. 3 up to and including 8 show a top view of the binding site in six examples of embodiments of sheets used in a binding system according to the present invention. FIG. 3 depicts a sheet 2 with approximate trapezoid tabs 4.

FIG. 4 shows a sheet 2 with approximate half-circular tabs 4.

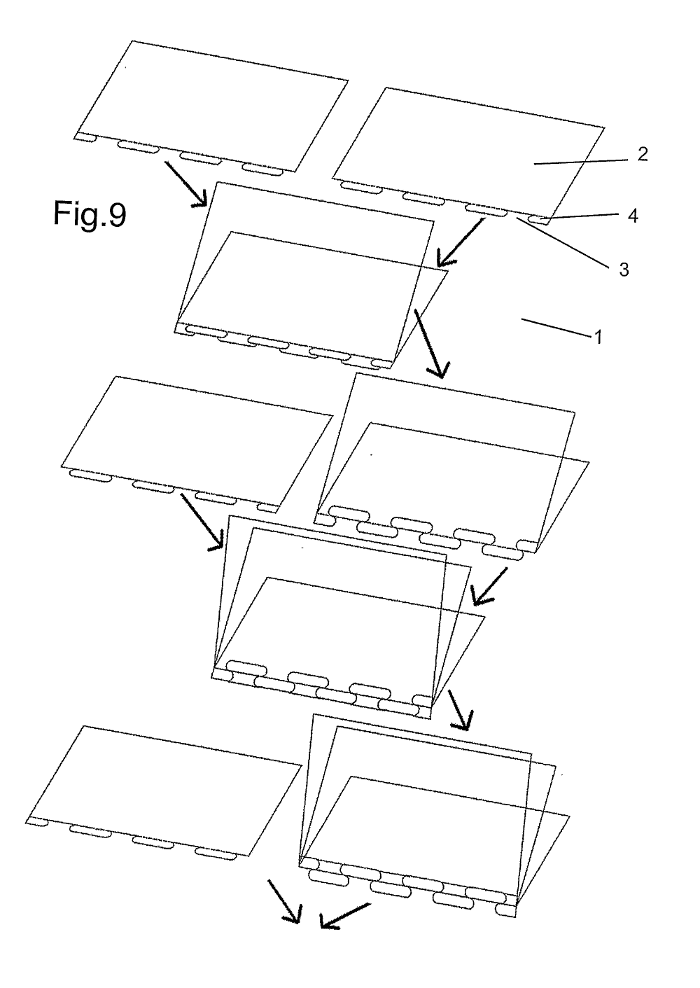

FIG. 5 depicts a sheet 2 with approximate triangular tabs 4. However the binding edge 3 can encompass tabs 4 with many other shapes and variations. FIG. 6 shows a binding edge 3 with rectangular tabs 4. In all these examples only one type of sheet 2 is used in the binding system. The number of tabs 4 on the binding edge 3 of the sheet 2 can vary if desired. FIG. 7 depicts a sheet 2 with trapezoid tabs 4 in which both ends of the binding edge 3 comprise a partial tab 4. FIG. 8 shows a sheet 2 with trapezoid tabs 4 in which both ends of the binding edge comprise a notch or tab-less part. Sheets according to the FIGS. 7 and 8 complement each other and are alternately bound together.

FIG. 9 depicts a perspective view of the consecutive stages of the binding process according to an embodiment example of the present invention. The binding system 1 comprises a stacking of sheets 2, that, at their binding edge 3, are provided with tabs 4. To manufacture booklets with more than two pages, one first connects two sheets 2 by inserting the tabs 4 of the upper sheet 2 between the tabs 4 of the lower sheet 2. Then the tabs 4 of the lower sheet 2 are folded back onto the upper sheet 2 and lie flat on this upper sheet 2. Only the tabs 4 of the upper sheet 2 are now left unfolded. A new sheet 2 is placed upon said pair connected sheets 2, with its tabs 4 positioned directly above the resulting notches between the tabs 4 of the upper sheet 2 in the connected pair. After this the tabs 4 of the new sheet 2 are pushed into these notches. Now the tabs 4 of the middle sheet 2 of the triple are folded back onto the upper sheet 2, and lie flat on this upper sheet 2, of the triple. One can repeat this procedure to create a booklet with any desired number of pages.

Although the invention was illustrated further with some embodiment examples, the present invention is certainly not limited to these. On the contrary, for the average professional many other variations and designs are possible within the scope of the invention. The sizes, shapes and number of tabs and sheets can vary if desired. Also the tabs do not need to be an integral part of the sheets but can be fastened to the sheets afterwards.

1. Binding system comprising:
at least two stackable sheets that are mutually connectable at a common binding side by attachment means,
tabs comprised by the attachment means at the binding side, the tabs projecting from the sheets and the tabs comprising a base width being the width of the tab at substantially the binding side of the sheet,
notches defined between the tabs, the notches having a base width, characterized in that:
the base width of the tabs and the notches is substantially the same,
the tabs of a first sheet are suitable for folding into the notches of an adjacent sheet to provide for a mutual attachment of those sheets along the binding side along a straight folding line, and in that,
the tabs each comprise a main section having a protrusion or a lug at one or both sides that are projecting from this main section and that are defining open recesses along the edge of the sheet from which the tab projects whereby
a part of the base of the main section of a tab substantially fits into a recess of the tab of an adjacent sheet.

2. Binding system according to claim 1 in which tabs of adjacent sheets are interlockable and hookable into each other.

3. Binding system according to claim 1 in which the notches comprise a bottom line that is straight and in line with the binding side of the sheet.

4. Binding system according to claim 1 in which the tabs are foldable over the bottom of a notch of an adjacent sheet.

5. Binding system according to claim 1 in which the tabs are characterised by a main section that comprises, along its base where the tab projects from the rest of the sheet, a weakening embodied by a folding line, perforated line or crease.

6. Binding system according to claim 1 in which the tabs are characterised by a weakening in the form of a folding line, perforated line or crease between main section and the protrusions.

7. Binding system according to claim 1 comprising one type of sheet that is characterised by an alternating sequence of tabs and notches on the binding side and that the sequence starts with a tab and ends with a notch.

8. Binding system according to claim 1 with two complementary types of sheets that are characterised by two different patterns of tabs and notches and the binding edge of each sheet either starts with a tab and ends with a tab or starts with a notch and ends with an notch.

9. Binding system according to claim 1 characterised by sheets comprising a printable material like paper, cardboard or plastic foil.

10. Binding system according to claim 1 that is characterised by tabs comprising additional attachment means in particular glue or more specifically a self-adhesive layer or a hot-melt layer.

11. Punching machine to fabricate sheets for use in a binding system according to claim 1.

12. Use of a binding system according to claim 1 for manufacturing a book, magazine, poster, photo-album or other bindable material characterised by a first sheet that is attachable to a second sheet by inserting its tabs into the notches of the second sheet, after which the tabs of the first sheet are folded onto the second sheet and a new third sheet is placed onto the second sheet of said pair of sheets, with its tabs insertable into the notches of that second sheet, after which the tabs of the second sheet are folded onto that third sheet and eventually more sheets can be attached to this triple in the same way.
